(19) United States
(12) Patent Application Publication
(10) Pub. No.: US 2023/0115891 A1
(43) Pub. Date: Apr. 13, 2023

(54) SYSTEM FOR DIRECT AIR CAPTURE USING OCEAN ENERGY AND FLUIDICS PRINCIPLES

(71) Applicant: LAWRENCE LIVERMORE NATIONAL SECURITY, LLC, Livermore, CA (US)

(72) Inventors: Maxwell Murialdo, Westminster, CA (US); Wenqin Li, Fremont, CA (US); Diego I. Oyarzun Dinamarca, Livermore, CA (US); Paul J. Durack, Livermore, CA (US)

(21) Appl. No.: 17/938,384

(22) Filed: Oct. 6, 2022

Related U.S. Application Data
(60) Provisional application No. 63/262,308, filed on Oct. 8, 2021.

(51) Int. Cl. B01D 53/04; B01D 53/62; B01D 53/82; B01D 53/96; C02F 1/14; B01D 1/00; B01D 5/00; C01B 32/55; F03B 13/14; F04F 10/00

(52) U.S. Cl. CPC B01D 53/0446; B01D 53/62; B01D 53/82; B01D 53/96; C02F 1/14; B01D 1/0035; B01D 5/006; C01B 32/55; F03B 13/14; F04F 10/00; B01D 2253/206; B01D 2258/06; B01D 2259/40083; C02F 2103/08

(57) ABSTRACT

A direct air capture system for use in a body of water that has waves with wave motion. The system includes at least one module exposed to the waves. The relative motion between the module and the waves to draws air into the module. The system removes carbon dioxide from the air using a moisture swing absorbent to remove the carbon dioxide from the air. The removed carbon dioxide can be used for various purposes.

### CROSS-REFERENCE TO RELATED APPLICATIONS

This application claims priority to and benefit under 35 U.S.C. § 119(e) of U.S. Provisional Patent Application No. 63/262,308 filed Oct. 8, 2021 entitled “System for Direct Air Capture Using Ocean Energy and Fluidics Principles,” the content of which is hereby incorporated by reference in its entirety for all purposes.

### STATEMENT AS TO RIGHTS TO APPLICATIONS MADE UNDER FEDERALLY SPONSORED RESEARCH AND DEVELOPMENT

This invention was made with Government support under Contract No. DE-AC52-07NA27344 awarded by the United States Department of Energy. The Government has certain rights in the invention.

### BACKGROUND

### Field of Endeavor

The present disclosure relates to a new approach for direct air capture that replaces massive fans on the land with apparatus, systems, and methods including at least one passive buoy module in the ocean or body of water with waves and uses wave motion to implement direct air capture.

### State of Technology

This section provides background information related to the present disclosure which is not necessarily prior art.

New research indicates that even if humans stopped emitting carbon dioxide into the atmosphere today, the world would continue to warm by up to 3 degrees Celsius (over preindustrial levels) due to a self-sustaining cycle and past human emissions. It is therefore necessary to consider methods of removing carbon dioxide from the atmosphere to keep the planet habitable.

The ocean is not only a possible CO₂ storage sink (in CO₂ clathrate form), but also an abundant and predominantly untapped source of renewable energy. While estimates vary wildly, it has been calculated that the ocean could provide up to 93,000 TWh of renewable energy annually, with waves comprising between 8,000 TWh and 80,000 TWh of power annually. However, almost none of this potential is currently being tapped.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

The inventors have developed a direct air capture system for use in a body of water that has waves with wave motion. The system includes at least one module exposed to the waves. In some embodiments the module floats on the body of water and the movement of the waves and module draws air into the module. In some other embodiments the module is maintained stationary and the movement of the waves on the stationary module draws air into the module.

The inventors' direct air capture system utilizes the relative motion between the module and the waves to draw air into the module. The system removes carbon dioxide from the air using a moisture swing absorbent to remove the carbon dioxide from the air. The removed carbon dioxide can be used for various purposes. In one or more embodiments the carbon dioxide is stored. In one or more embodiments the system includes providing a reactor in the module that produces carbon dioxide clathrates from the carbon dioxide that has been removed from the air. The carbon dioxide clathrates sink in the body of water. In one embodiment the carbon dioxide clathrates are directed into a conduit extending at least 500 meters into the body of water allowing the carbon dioxide clathrates to sink in the body of water.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 is a view that illustrates one embodiment of apparatus, systems, and methods for direct air capture.

FIG. 2 is an illustrative view that shows details of a portion of Applicant's apparatus, systems, and methods embodiment 100 illustrated in FIG. 1.

FIG. 3 is an illustrative view that shows another embodiment of Applicant's apparatus, systems, and methods for direct air capture.

FIG. 4 illustrates another embodiment of apparatus, systems, and methods for direct air capture.

FIG. 5 illustrates an alternate implementation of a subsystem that pumps carbon dioxide down to a depth in the ocean

FIG. 6 illustrates another embodiment of apparatus, systems, and methods for direct air capture.

FIG. 7 illustrates an example subsystem that could be used within the invention in order to take in cold water from deep in the ocean and pump it vertically towards the ocean surface, without using complex moving mechanical parts.

FIG. 8 is an illustrative view that shows another embodiment of Applicant's apparatus, systems, and methods.

FIGS. 9A 9B, and 9C are diagrams A through I that show the approximate flow of water throughout the subsystem.

FIG. 10 is an illustrative view of an embodiment of apparatus, systems, and methods for direct air capture and CO₂ storage.

FIG. 11 is an illustrative view of another embodiment of apparatus, systems, and methods for direct air capture and CO₂ storage.

FIG. 12 is an illustrative view of an embodiment of apparatus, systems, and methods for direct air capture and CO₂ sequestration.

FIG. 13 is an illustrative view of another embodiment of apparatus, systems, and methods for direct air capture and CO₂ sequestration.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

The inventors' apparatus, systems, and methods will now be described by way of non-limitative examples which illustrate individual embodiments of the inventor's apparatus, systems, and methods. One important purpose of the inventors' apparatus, systems, and methods is to remove carbon dioxide directly from the atmosphere in a way that is cost effective and scalable. A number of studies indicate that removing carbon dioxide from the atmosphere (negative emissions technologies) is essential in our efforts to combat climate change. Various embodiments of the inventors' apparatus, systems, and methods provide a passive buoy module that can capture carbon dioxide from the atmosphere by harnessing ocean wave energy. This new approach to direct air capture has virtually no moving parts, making each buoy module robust, low maintenance, passively operated, and inexpensive to manufacture. When parked in the ocean, the natural rise and fall of waves around ports in the buoy module drive pressure differences and fluid flows of CO₂, air, and water throughout the internal chambers of the module. These internal chambers are designed to mimic well-known fluidic devices that can pump water, compress air, control the direction of fluid flow, and self-prime for siphoning, all without any moving parts.

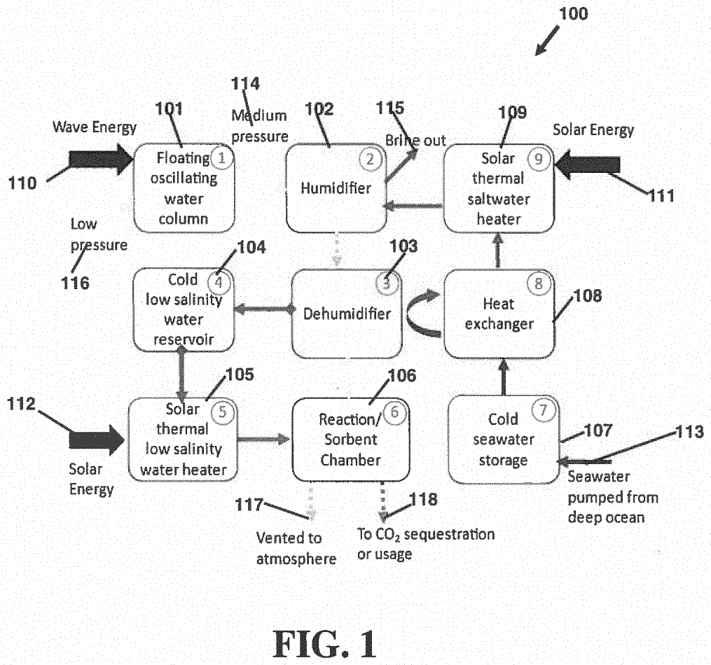

Referring now to FIG. 1, an illustrative view shows an embodiment of Applicant's apparatus, systems, and methods. This embodiment is identified generally by the reference numeral 100. The components of Applicant's apparatus, systems, and methods embodiment 100 illustrated in FIG. 1 are listed below:
Reference Numeral No. 101—floating oscillating water column,
Reference Numeral No. 102—humidifier,
Reference Numeral No. 103—dehumidifier,
Reference Numeral No. 104—cold low salinity water reservoir,
Reference Numeral No. 105—solar thermal low salinity water heater,
Reference Numeral No. 106—reaction sorbent chamber,
Reference Numeral No. 107—cold water storage,
Reference Numeral No. 108—heat exchanger,
Reference Numeral No. 109—solar thermal saltwater heater,
Reference Numeral No. 110—wave energy,
Reference Numeral No. 111—solar energy,
Reference Numeral No. 112—solar energy,
Reference Numeral No. 113—seawater pumped from deep ocean,
Reference Numeral No. 114—medium pressure,
Reference Numeral No. 115—brine out,
Reference Numeral No. 116—low pressure,
Reference Numeral No. 117—vented to atmosphere, and
Reference Numeral No. 118—to CO₂ sequestration or usage.

The description of the components of the embodiment of Applicant's apparatus, systems, and methods 100 having been completed, the operation and additional description of the Applicant's apparatus, systems, and methods 100 will now be considered in greater detail.

Reference Numeral No. 101—floating oscillating water column,

The floating oscillating water column comprises a large mass that is floating on the surface of the body of water with a lower opening wherein water may enter and exit. The large mass provides inertia against motion such that the motion of the waves is temporally offset from the motion of the oscillating water column. Accordingly, water is forced into and out of the lower opening, displacing air within the internal cavity of the oscillating water column. The displaced air is pressurized to a medium pressure by the wave energy, producing air flow to the subsequent components of the system.

Reference Numeral No. 102—humidifier,

The humidifier increases the temperature and water content of the input air stream. This can be achieved by bubbling air through warm water (for example using a sparger plate).

Reference Numeral No. 103—dehumidifier,

The dehumidifier reduces the temperature of the warm humid air, thereby causing water vapor to condense out of the air (generating freshwater or low salinity water). This can be achieved by bubbling air through cold, low salinity water (for example using a sparger plate.) The output air has less water content than the input air.

Reference Numeral No. 104—cold low salinity water reservoir,

This reservoir provides temporary storage space for low salinity overflow water generated in the dehumidifier. While the water is initially cold (from the dehumidifier), it can be warmed by indirect thermal contact with ocean surface water or solar radiation.

Reference Numeral No. 105—solar thermal low salinity water heater,

This chamber draws in water from the cold low salinity water reservoir and heats the water by absorbing solar radiation into its dark surface and transferring the thermal energy to the water. This chamber helps to precondition the water for the reaction sorbent chamber.

Reference Numeral No. 106—reaction sorbent chamber,

The reactor sorbent chamber separates CO2 from air using a moisture swing absorbent. Absorbent material within the chamber chemically captures CO2 when dry and releases CO2 when the moisture content contacting the sorbent increases, due to an equilibrium shift. An example of a moisture swing absorbent is an anion exchange resin. The chamber alternates between CO2 loading and unloading conditions. The timing of this alternating cycle can be directed with self-priming siphons. Low salinity water is introduced into contact with the sorbent for the regeneration step. The water is removed during the loading step.

Reference Numeral No. 107—cold water storage,

Cold seawater pumped up from the deep ocean is temporarily stored in this chamber until it can pass through the heat exchanger. This storage container can be insulated to prevent inadvertent heating of the water within.

Reference Numeral No. 108—heat exchanger,

The heat exchanger removes heat from the low salinity water in the dehumidifier by creating indirect thermal contact between the low salinity water in the dehumidifier and the colder high salinity water drawn in from the cold-water storage.

Reference Numeral No. 109—solar thermal saltwater heater,

The solar thermal saltwater heater absorbs solar radiation incident on a dark color medium, which in turn heats saltwater passing in contact with the dark color medium, by thermal conduction.

Reference Numeral No. 110—wave energy,

Energy embodied in the rise and fall of the surface of the body of water deriving from wind flowing across the surface of the body of water. Some of this energy can be captured in the oscillating water column.

Reference Numeral No. 111—solar energy,

Energy derived from sunlight shining on and being absorbed by a dark color medium. This medium can transfer the heat to water in contact with it.

Reference Numeral No. 112—solar energy,

Energy derived from sunlight shining on and being absorbed by a dark color medium. This medium can transfer the heat to water in contact with it.

Reference Numeral No. 113—seawater pumped from deep ocean,

At specific locations within the ocean, deep seawater (for example from a depth approximately 500 meters below the surface of the ocean) is colder than surface seawater. The cold deep seawater can be pumped up towards the surface of the ocean through a long vertical or partially vertical pipe. The temperature gradient between seawater pumped from deep ocean and surface seawater can be utilized as a source of energy.

Reference Numeral No. 114—medium pressure,

The oscillating water column generates moderate or medium pressure increases in input air above atmospheric pressure that drive the flow of air through the system.

Reference Numeral No. 115—brine out,

As water is removed from the humidifier (carried out in the air stream), the saltwater internal to the humidifier increases in salinity and is considered brine. This brine is expelled from the humidifier back into the ocean.

Reference Numeral No. 116—low pressure,

The oscillating water column pulls in low pressure air (approximately one atmosphere) as its input.

Reference Numeral No. 117—vented to atmosphere, and

Air and/or water vapor are vented to the atmosphere after passing through the reactor sorbent chamber.

Reference Numeral No. 118—to CO₂ sequestration or usage.

CO₂ is separated from the air in the reactor sorbent chamber and redirected towards the desired CO₂ sequestration or usage location.

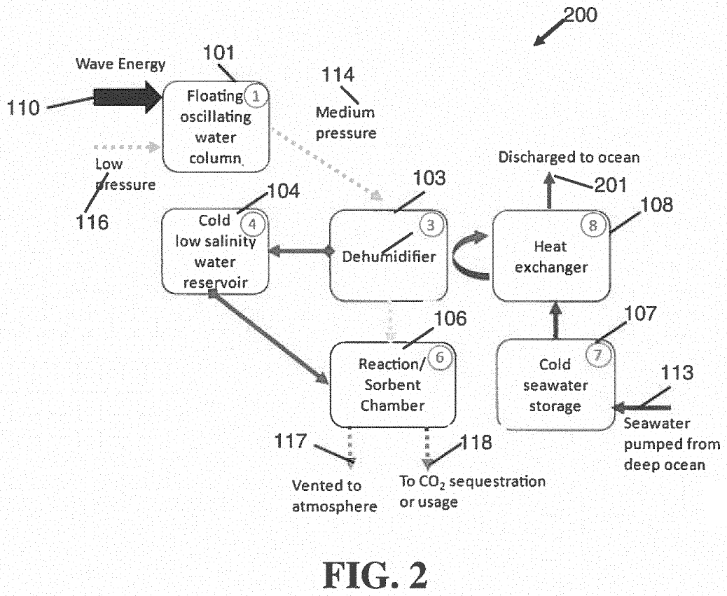

Referring now to FIG. 2, an illustrative view shows details of a portion of Applicant's apparatus, systems, and methods embodiment 100 illustrated in FIG. 1. This embodiment is identified generally by the reference numeral 200. The components of Applicant's apparatus, systems, and methods embodiment 200 illustrated in FIG. 2 are listed below:
Reference Numeral No. 101—floating oscillating water column,
Reference Numeral No. 103—dehumidifier,
Reference Numeral No. 104—cold low salinity water reservoir,
Reference Numeral No. 106—reaction sorbent chamber,
Reference Numeral No. 107—cold water storage,
Reference Numeral No. 108—heat exchanger,
Reference Numeral No. 110—wave energy,
Reference Numeral No. 113—seawater pumped from deep ocean,
Reference Numeral No. 116—low pressure,
Reference Numeral No. 117—vented to atmosphere, and
Reference Numeral No. 118—to CO₂ sequestration or usage.

The description of the components of the embodiment of Applicant's apparatus, systems, and methods 200 having been completed, the operation and additional description of the Applicant's apparatus, systems, and methods 200 will now be considered in greater detail.

Reference Numeral No. 101—floating oscillating water column,

The floating oscillating water column comprises a large mass that is floating on the surface of the body of water with a lower opening wherein water may enter and exit. The large mass provides inertia against motion such that the motion of the waves is temporally offset from the motion of the oscillating water column. Accordingly, water is forced into and out of the lower opening, displacing air within the internal cavity of the oscillating water column. The displaced air is pressurized to a medium pressure by the wave energy, producing air flow to the subsequent components of the system.

Reference Numeral No. 103—dehumidifier,

The dehumidifier reduces the temperature of the warm humid air (from the atmosphere), thereby causing water vapor to condense out of the air (generating freshwater or low salinity water). This can be achieved by bubbling air through cold, low salinity water (for example using a sparger plate.) The output air has less water content than the input air.

Reference Numeral No. 104—cold low salinity water reservoir,

This reservoir provides temporary storage space for low salinity overflow water generated in the dehumidifier. While the water is initially cold (from the dehumidifier), it can be warmed by indirect thermal contact with ocean surface water or solar radiation.

Reference Numeral No. 106—reaction sorbent chamber,

The reactor sorbent chamber separates CO₂ from air using a moisture swing absorbent. Absorbent material within the chamber chemically captures CO₂ when dry and releases CO₂ when the moisture content contacting the sorbent increases due to an equilibrium shift. An example of a moisture swing absorbent is an anion exchange resin. The chamber alternates between CO₂ loading and unloading conditions. The timing of this alternating cycle can be directed with self-priming siphons. Low salinity water is introduced into contact with the sorbent for the regeneration step. The water is removed during the loading step.

Reference Numeral No. 107—cold water storage,

Cold seawater pumped up from the deep ocean is temporarily stored in this chamber until it can pass through the heat exchanger. This storage container can be insulated to prevent inadvertent heating of the water within.

Reference Numeral No. 108—heat exchanger,

The heat exchanger removes heat from the low salinity water in the dehumidifier by creating indirect thermal contact between the low salinity water in the dehumidifier and the colder high salinity water drawn in from the cold-water storage.

Reference Numeral No. 110—wave energy,

Energy embodied in the rise and fall of the surface of the body of water deriving from wind flowing across the surface of the body of water. Some of this energy can be captured in the oscillating water column.

Reference Numeral No. 113—seawater pumped from deep ocean,

At specific locations within the ocean, deep seawater (for example from a depth approximately 500 meters below the surface of the ocean) is colder than surface seawater. The cold deep seawater can be pumped up towards the surface of the ocean through a long vertical or partially vertical pipe. The temperature gradient between seawater pumped from deep ocean and surface seawater can be utilized as a source of energy.

Reference Numeral No. 116—low pressure,

The oscillating water column generates moderate or medium pressure increases in input air above atmospheric pressure that drive the flow of air through the system.

Reference Numeral No. 117—vented to atmosphere, and

Air and/or water vapor are vented to the atmosphere after passing through the reactor sorbent chamber.

Reference Numeral No. 118—to CO₂ sequestration or usage.

CO₂ is separated from the air in the reactor sorbent chamber and redirected towards the desired CO₂ sequestration or usage location.

The system (100/200) uses renewable energy inputs to separate and capture carbon dioxide out of the air, and then facilitate sequestration or use of the captured carbon dioxide. Moreover, this system functions without the use of any complex, solid moving parts. With the exception of simple check valves and float valves, the only relative motion within the system occurs in the liquid, gas, or mixed liquid/gas phases. The absence of complex solid moving parts simplifies the construction and operation of the system, reducing capital expenses, maintenance expenses, and operating expenses (systems requiring complex moving parts have the potential to jam, wear down with use, or otherwise malfunction and are not as robust as systems without complex moving parts.)

The floating oscillating water column draws in air from the surrounding atmosphere and uses wave energy to slightly compress the air to medium or moderate pressures. This slight compression provides the driving force that causes the air to flow through the connecting pipes and chambers of the system. The oscillating water column floats on the surface of the body of water. As waves pass across the surface of this body of water, the floating oscillating water column rises and falls in response. However, due the large mass and large inertia of the floating oscillating water column, there is a phase shift between the motion of the floating oscillating water column and the motion of the waves. This phase shift causes the wave water to be forced into the lower opening of the oscillating water column, thereby reducing the gas-phase volume within the chamber internal to the floating oscillating water column and compressing the air contained within.

In general, the intake air that is compressed to medium or moderate pressure within the floating oscillating water column is at nearly the same temperature as the surface water within the body of water and at nearly one hundred percent relative humidity (for this temperature condition).

The intake air is warmed, and its water content is increased in the humidifier. As an example of how this process occurs, the compressed intake air is forced to bubble up through heated saltwater by forcing the air through a sparger plate at the bottom of a container of heated saltwater. During the bubbling, both thermal transport and mass transport occur, so that the air bubbles become heated to close to the temperature of the surrounding heated saltwater. Simultaneously, the water content of the air bubbles is increased so that the air within the bubbles is at nearly one hundred percent relative humidity (for the new air bubble temperature condition). This process results in a removal of water from the humidifier as water is added to the air stream and flowed out of the humidifier.

The air from the humidifier is directed into the dehumidifier. As an example of how this process occurs, the compressed intake air (from the humidifier) is forced to bubble up through cold low salinity water by forcing the air through a sparger plate at the bottom of a container of cold low salinity water. During the bubbling, both thermal transport and mass transport occur, so that the air bubbles become cooled to close to the temperature of the surrounding cold low salinity water. Simultaneously, the water content of the air bubbles is decreased so that the air within the bubbles is at nearly one hundred percent relative humidity (for the new air bubble temperature condition). This process results in a removal of water from the air bubbles as water condenses out into the dehumidifier. The humidifier and dehumidifier together constitute a humidification/dehumidification desalination process to generate low salinity water or freshwater. The dried (and cooled) air is next directed to the reaction sorbent chamber.

The freshwater generated by the humidification/dehumidification desalination process is stored in a container that may be in thermal contact with the surface ocean water. This low salinity water emerges cold from the humidification/dehumidification desalination process. By storing this cold, low salinity water in contact with warmer (surface) saltwater, the cold low salinity water is slightly warmed. This warmed water is then fed into a solar thermal low salinity water heater where the low salinity water is further heated by the input of solar energy. As an example of how a solar thermal water heater can work, it can be comprised of pipes passing through a dark material with high heat capacity and high thermal conductivity. This setup can have external insulation to trap heat in, along with a transparent window which allows incident solar radiation to impinge on and be absorbed by the dark material. Solar rays passing through the transparent window and impinging on and being absorbed by the dark material cause the dark material to heat up. Furthermore, insulation surrounding the dark material can help to trap this heat in. The water can be flowed through the pipes (which are in thermal contact with the dark material), causing the water to absorb and carry away much of the accumulated heat by thermal transport. A solar thermal water heater can achieve temperatures in excess of 50° C. A simplified version of a solar thermal water heater can consist of dark, thermally conductive tubes that transport water through them and absorb solar radiation at their exteriors.

The flow of saltwater (or seawater) can also be tracked through the system. (Note that the water referred to as saltwater or seawater is the external common water in the body of water in which the system floats regardless of the water's actual salinity.) Only two internal portions of the system are exposed to seawater. The first portion is the aforementioned oscillating water column. In one instantiation of this system, the seawater entering into the system is drawn from deep in the ocean (for example at a depth of greater than 500 meters below the surface of the ocean.) At this depth the seawater is much colder than seawater at the surface of the ocean. In addition to wave energy and direct solar thermal energy, the temperature difference between deep ocean water and surface ocean water provides a third source of renewable energy input (ocean thermal energy). The cold water from the deep ocean is pumped into an insulated cold seawater storage container. This water is then directed through a heat exchanger, which serves to transfer heat from the freshwater reservoir in the dehumidifier to the cold seawater. This serves two purposes. First, it extracts heat from the dehumidifier, which is essential to the humidification/dehumidification desalination process. Second, it pre-warms the saltwater, which is then further heated in the solar thermal saltwater heater. The solar thermal saltwater heater uses solar radiation to heat the fluid flowing through it. The heated saltwater is then directed into the humidifier. As water is extracted from the heated saltwater in the humidifier, the salinity increases, producing brine, which is ejected from the system back into the ocean.

The carbon dioxide capture process occurs in the reaction sorbent chamber. This chamber takes in cold dry air from the dehumidifier and warm low salinity water from the solar thermal low salinity water heater (at various intervals). The carbon dioxide capture process employed is moisture swing absorption. In this process, a sorbent (such an anion exchange resin) absorbs carbon dioxide when it is dry, and releases carbon dioxide when in the presence of moisture (e.g., water vapor or liquid water). This process is driven by a water mediated shift in the chemical equilibrium (for example shifting an equilibrium balance between carbonate and hydroxide functional groups on the sorbent, and hence shifting the equilibrium sorption capacity of carbon dioxide on the sorbent.) In this system, airflow is directed through the sorbent bed until it is loaded with carbon dioxide. Next, low salinity water is introduced into the chamber to release the carbon dioxide bound to the sorbent (and regenerate the sorbent). The carbon dioxide is separated from the low salinity water based on the phase difference between the two fluids (gas vs liquid). The carbon dioxide is redirected towards its intended sequestration or usage. The excess low salinity water is retained within the system for use in a future regeneration cycle. In order to complete the carbon dioxide separation cycle, air is again flowed over the sorbent. This air flow dries the sorbent by removing any excess residual water, which is expelled to the atmosphere. After drying the sorbent, this airflow proceeds to capture carbon dioxide.

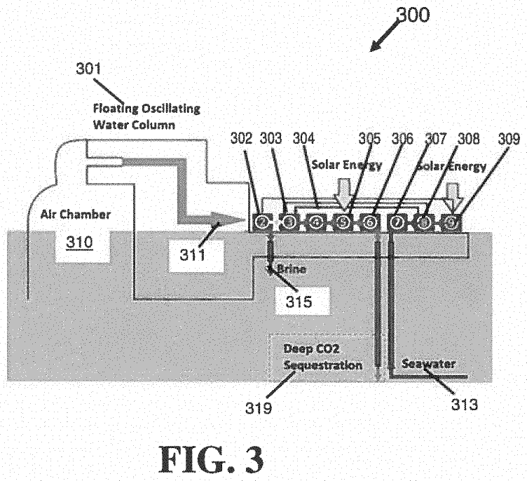

Referring now to FIG. 3, an illustrative view shows another embodiment of Applicant's apparatus, systems, and methods. This embodiment is identified generally by the reference numeral 300. The components of Applicant's apparatus, systems, and methods embodiment 300 illustrated in FIG. 3 are listed below:
Reference Numeral No. 301—oscillating water column,
Reference Numeral No. 302—humidifier,
Reference Numeral No. 303—dehumidifier,
Reference Numeral No. 304—cold low salinity water storage,
Reference Numeral No. 305—solar thermal low salinity water heater,
Reference Numeral No. 306—reaction/sorbent chamber,
Reference Numeral No. 307—cold seawater storage,
Reference Numeral No. 308—heat exchanger,
Reference Numeral No. 309—solar thermal saltwater heater,
Reference Numeral No. 310—air chamber,
Reference Numeral No. 311—arrow,
Reference Numeral No. 313—seawater pumped from deep ocean,
Reference Numeral No. 315—brine out, and
Reference Numeral No. 319—deep CO₂ sequestration.

The description of the components of the embodiment of Applicant's apparatus, systems, and methods 100 having been completed, the operation and additional description of the Applicant's apparatus, systems, and methods 100 will now be considered in greater detail.

FIG. 3 is a side view of one potential implementation of the inventor's system, visualized. Due to waves on the surface of the body of water, the seawater level in the Air Chamber 310 of the floating oscillating water column increases and decreases periodically. This process drives air flow through subsystems 302 through 309 as indicated by the arrow 311. The subsystems 302 through 309 comprise the humidifier 302, dehumidifier 303, cold low salinity water storage 304, solar thermal low salinity water heater 305, reaction sorbent chamber 306, cold seawater storage 307, heat exchanger 308, and solar thermal saltwater heater 309 respectively. Solar energy inputs to the solar thermal water heaters are pictured, as is the brine ejection 315 into the ocean from the humidifier 302. The entire system is floating, and most of the critical chambers are situated on top of the floating structure, outside of the seawater. Long, vertical pipes connecting the floating structure to intake and output ports deep in the ocean (approximately 500 meters) are also shown. These pipes can be connected indirectly to the floating system with flexible piping connections. Furthermore, large diameter pipes can connect to and service multiple floating modules. The intake pipes serve to pump cold water deep in the ocean up towards the ocean surface and can be insulated. The output pipes can allow carbon dioxide to be pumped down to a depth of 500 meters in the ocean for sequestration purposes. For example, at this depth the carbon dioxide could be mixed with seawater by pushing it through a mixing reactor in order to form carbon dioxide clathrates (also called hydrates). These clathrates are generally stable at ocean depths of greater than 500 meters and are denser than seawater. Thus, once formed, the carbon dioxide clathrates sink to the bottom of the ocean, where they sequester carbon dioxide in a solid matrix over useful timeframes.

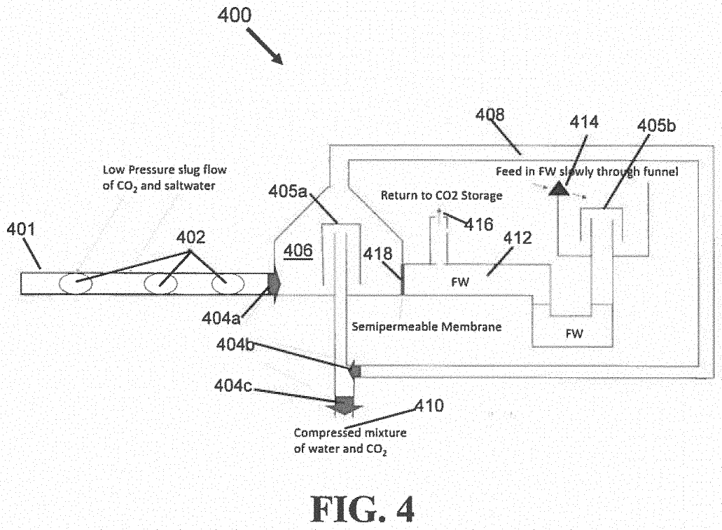

Referring now to FIG. 4, an illustrative view shows another embodiment of Applicant's apparatus, systems, and methods. This embodiment is identified generally by the reference numeral 400. The components of Applicant's apparatus, systems, and methods embodiment 400 illustrated in FIG. 4 are listed below:
Reference Numeral No. 401—input pipe,
Reference Numeral No. 402—low pressure slug flow of CO₂ and saltwater,
Reference Numeral No. 404—check valve number one,
Reference Numeral No. 404b—check valve number two,
Reference Numeral No. 404c—check valve number three,
Reference Numeral No. 405a—bell siphon number one,
Reference Numeral No. 405b—bell siphon number two,
Reference Numeral No. 406—main reservoir,
Reference Numeral No. 408—flow path,
Reference Numeral No. 410—compressed mixture of water and CO₂,
Reference Numeral No. 412—freshwater flow channel,
Reference Numeral No. 414—funnel,
Reference Numeral No. 416—return to CO₂ storage, and
Reference Numeral No. 418—semipermeable membrane.

The description of the components of the embodiment of Applicant's apparatus, systems, and methods 400 having been completed, the operation and additional description of the Applicant's apparatus, systems, and methods 400 will now be considered in greater detail.

FIG. 4 illustrates one possible implementation of a pumping subsystem that can be used to generate higher pressures. This pumping subsystem can be used to pump captured carbon dioxide down to a deeper location in the ocean for sequestration. This subsystem makes use of a bell siphons, semipermeable membranes and check valves, but does not contain complex moving parts. The predominant driving force is the osmotic potential created by placing freshwater (or low salinity water) and saltwater on opposite sides of a semipermeable membrane. The predominant driving force is thus osmotic energy (due to entropy of mixing), fueled by the mixture of freshwater and saltwater. The osmotic pressure of mixing freshwater and seawater can be in excess of many atmospheres.

In this subsystem 400, gaseous carbon dioxide is carried along an input pipe by intermitted regions filled with saltwater (e.g., in a plug flow fashion) 402. This mixed phase fluid passes through check valve number one 404a into the main reservoir 406 of the subsystem. Within the main reservoir of the subsystem, the saltwater accumulates at the bottom, and due to its lower density than saltwater, the gaseous carbon dioxide accumulates in the upper region of the main reservoir and the connecting pipe. Through a check valve number two 404b, the carbon dioxide is also allowed to fill bell siphon number one and its connecting central tube. The carbon dioxide pressure internal to bell siphon number one is thus in contact with and is generally in equilibrium with the carbon dioxide pressure at the top of the reservoir. If the pressure in the central tube of check valve number two exceeds the backpressure that keeps check valve number three in a closed position, then check valve number three will open and allow fluid (e.g., carbon dioxide and or seawater) to pass through it in a forward direction (and under pressure). The input saltwater from the input pipe is dosed into the system so that the saltwater level is above the lower opening of bell siphon number one, but below the upper opening in bell siphon number one. This dosing can be achieved with an additional (non-pictured) bell siphon apparatus. This creates a water seal around bell siphon number one. The bell siphon will not allow liquid to flow up and over the upper opening of bell siphon number one, unless the surrounding liquid level is at or exceeds the height of the upper opening of bell siphon number one. However, once the surrounding liquid level reaches this minimum level required to induce siphoning action in bell siphon number one, then bell siphon number one will proceed to siphon the liquid from the main reservoir until the main reservoir liquid level is at or below the level of the lower opening on bell siphon number one. A bell siphon is also known as type of self-priming siphon.

In step one, low pressure seawater and carbon dioxide are dosed into the main reservoir through the input pipe 401 and a check valve number one 404a. The carbon dioxide accumulates at the top of the main reservoir, in the CO₂ flow path, and in the central connecting tube. In step two, freshwater (or low salinity water) is dosed into the freshwater flow channel 412 through a funnel 414 and bell siphon number two 405b. (Note that bell siphon number two will dose freshwater into the freshwater flow channel with periodicity dictated by the dimensions of bell siphon number two and the continuous flowrate of water through the funnel.) The freshwater flow channel and the main reservoir are connected by a semipermeable membrane. By osmosis the freshwater will force its way through the semipermeable membrane and into the main reservoir, thereby diluting the salinity of the main reservoir. The influx of water in the main reservoir (through the semipermeable membrane and driven by osmotic pressure) will compress the carbon dioxide gas and increase the water level in the main reservoir. Step three occurs when the water level in the main reservoir reaches or exceeds the level of the upper opening in bell siphon number one. At this point, siphoning action in bell siphon number one is achieved and the water in the main reservoir is siphoned down the central connecting tube (under pressure). This pressurized water along with carbon dioxide is ultimately pumped through check valve number three. The design of the junction between the flow path and the central connecting tube to bell siphon number one can be altered to adjust the composition of the water/carbon dioxide two-phase fluid flow through check valve number three. The water level in the main reservoir will now be below the lower opening of bell siphon number one. The freshwater in the freshwater flow channel will also be at a low level. Therefore, the carbon dioxide, no longer blocked by saltwater or freshwater can leak through the semipermeable membrane and return to a low-pressure carbon dioxide storage chamber through 416. Once the pressure in the main reservoir is low enough, check valve number one will allow additional saltwater and carbon dioxide into the main reservoir and repeat the cycle. Note that the timing is predominantly implemented with batch dosing using bell siphons.

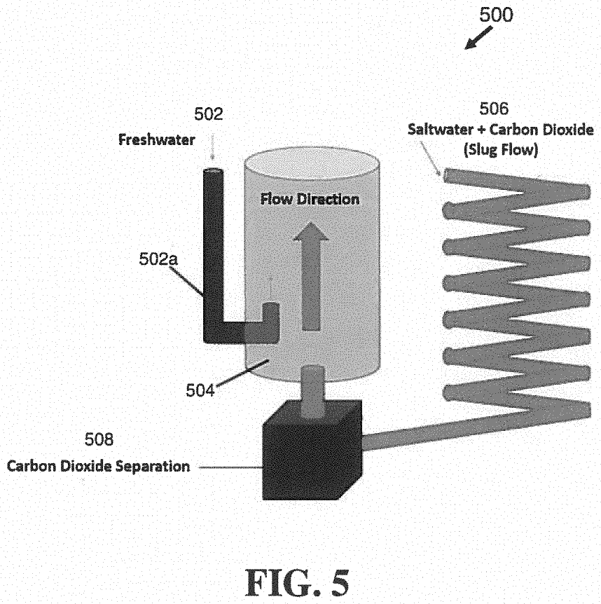

Referring now to FIG. 5, an illustrative view shows another embodiment of Applicant's apparatus, systems, and methods. This embodiment is identified generally by the reference numeral 500. The components of Applicant's apparatus, systems, and methods embodiment 500 illustrated in FIG. 5 are listed below:
Reference Numeral No. 502—freshwater,
Reference Numeral No. 504—vertical large diameter pipe,
Reference Numeral No. 506—saltwater plus Carbon Dioxide (Slug Flow), and
Reference Numeral No. 508—carbon dioxide separation.

The description of the components of the embodiment of Applicant's apparatus, systems, and methods 500 having been completed, the operation and additional description of the Applicant's apparatus, systems, and methods 500 will now be considered in greater detail.

FIG. 5 is an illustration of an alternate implementation of a subsystem that pumps carbon dioxide down to a depth in the ocean as depicted. In this figure, the driving force is the entropy of mixing between freshwater (or low salinity water) and saltwater, however, notably, this subsystem does not use any semipermeable membranes (which can incur capital expenses, maintenance expenses, and may clog or otherwise deteriorate and require repair or replacement.) This subsystem operates on hydrocratic principles similar to the operation of the hydrocratic generator.

A hydrocratic generator pumps freshwater (or low salinity water) 502 down a vertical L-shaped tube, the ending of which terminates near the lower opening of a vertical large diameter pipe 504 full of saltwater and open at both ends. The bulk of the hydrocratic generator is submerged in a salty body of water such as an ocean. The influx of lower density freshwater into the large diameter pipe (injected from the L-shaped tube) causes an upward flow of water within the large diameter pipe. The flow rate of this upward liquid motion is further increased by the entropy of mixing between the freshwater and the saltwater (a hydrocratic effect).

In this system, the upward flow within the large diameter pipe is used to draw flow through the zig-zag pipe. At the top entrance of the zig-zag pipe, a two-phase slug flow 506 comprised of carbon dioxide and saltwater is injected. The purpose of this subsystem is to pump carbon dioxide down to a depth in the ocean for sequestration. The carbon dioxide is mixed with saltwater in a two-phase slug flow fashion in order to reduce the absolute pumping pressure needed to achieve the goal. The pipe can be angled in a zig-zag (resembling switchbacks), corkscrew, or other fashion in order to help maintain slug flow throughout the system. In order to drive the two-phase fluid to flow down the pipe (with a lower outlet in the deep ocean), the pressure inside the pipe at the lower outlet must exceed the ocean pressure pushing back from the surrounding ocean water outside the pipe. The pressure pushing back is a simple function of the average density of the ocean water above the lower outlet (ρₛ), the acceleration due to gravity (g), and the height of ocean water above the lower outlet (hₛ), yielding a pressure of ρₛghₛ pushing back on the outlet. The pressure inside the outlet (pushing back on the ocean) is a simple function of the average density of the two-phase fluid above the lower outlet (ρₜ), the acceleration due to gravity (g), and the height of the two-phase fluid (within the piping) above the lower outlet (hₜ), plus any applied pressure at the inlet of the zig-zag pipe, Pₐₚₚ, yielding a pressure of ρₜghₜ+Pₐₚₚ. The goal of generating a two-phase slug flow (as opposed to a pure carbon dioxide flow) is to increase ρₜ and thereby reduce the minimum Pₐₚₚ needed to induce downward flow of the carbon dioxide in the pipe for a given hₜ=hₛ. The parameter ρₜ can be increased above the value for pure carbon dioxide by mixing seawater with carbon dioxide because seawater has a significantly higher density than gaseous carbon dioxide. By adjusting the ratio of the liquid seawater to gaseous carbon dioxide within the two-phase flow, the minimum Pₐₚₚ needed can be adjusted.

At the bottom of the zig-zag pipe, the carbon dioxide in the flow is separated 508 from the seawater in the flow. If the carbon dioxide has liquified under the lower outlet temperature and pressure conditions (depending on depth and location), then the carbon dioxide can be separated from the seawater by density and buoyancy differences (e.g., less dense liquid carbon dioxide will rise to the top). If the carbon dioxide is still in the gaseous phase, then it can be separated from the liquid seawater by either density/buoyancy effects or phase effects (gas phase vs liquid phase). Once separated, the carbon dioxide is redirected towards its sequestration or use case, while the seawater is redirected into the large diameter pipe.

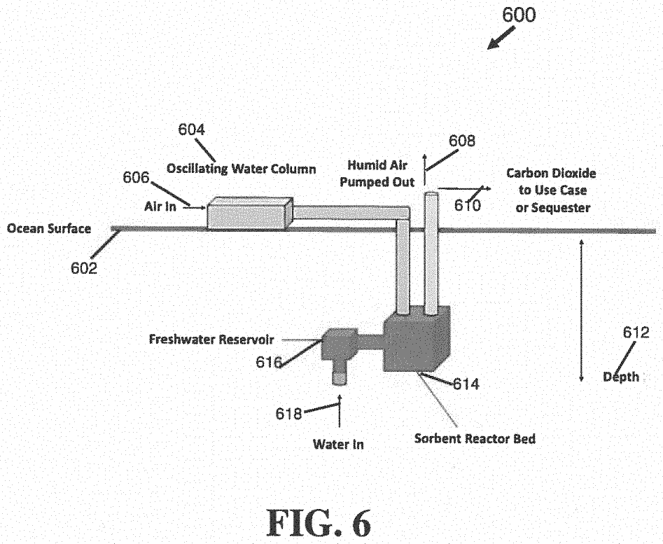

Referring now to FIG. 6, an illustrative view shows another embodiment of Applicant's apparatus, systems, and methods. This embodiment is identified generally by the reference numeral 600. The components of Applicant's apparatus, systems, and methods embodiment 600 illustrated in FIG. 6 are listed below:
Reference Numeral No. 602—ocean surface,
Reference Numeral No. 604—oscillating water column,
Reference Numeral No. 606—air in,
Reference Numeral No. 608—humid air pumped out,
Reference Numeral No. 610—carbon dioxide to use or sequester,
Reference Numeral No. 612—depth,
Reference Numeral No. 614—sorbent reactor bed,
Reference Numeral No. 616—fresh water reservoir, and
Reference Numeral No. 618—water in.

The description of the components of the embodiment of Applicant's apparatus, systems, and methods 600 having been completed, the operation and additional description of the Applicant's apparatus, systems, and methods 600 will now be considered in greater detail.

In FIG. 6, an alternate implementation of the system is shown. The key difference in this implementation is the means by which the freshwater (necessary for sorbent regeneration) is generated. In FIG. 6, freshwater is generated by reverse osmosis at the “water in” inlet 618. This inlet has a semipermeable membrane across it, which allows water to pass through, but rejects salts and other solutes. The driving force pushing water into the membrane is a pressure difference across the membrane. The pressure outside of the inlet (pushing in) is due to the weight of water above the inlet and is given by the expression ρₛgh, where ρₛ is the average density of the seawater above the inlet, g is the acceleration due to gravity, and h is the height between the water inlet and the ocean surface, given by Depth 612. The pressure within the system is approximately atmospheric pressure. In order for this method of freshwater generation to work, the difference in pressure between the exterior of the Water In inlet 618 and the interior of the system must be greater than the osmotic pressure of freshwater and seawater across a semipermeable membrane. This criterion sets the minimum depth for Depth 612.

In this system, air is pulled in 606 near the ocean surface 602 and pumped through the system by an oscillating water column 604 (that derives its pumping action from the motion of the waves). The air flows through Sorbent Reactor Bed 614, where carbon dioxide is captured out of the air by a moisture swing absorbent. The absorbent is regenerated by contact with liquid freshwater, which causes the captured carbon dioxide to desorb and flow up the escape pipe 608. Internally (but not shown) the escape pipe is segregated into two parallel sections, one through which carbon dioxide flows to sequestration or use cases, and a second through which humid air that has been stripped of some of its carbon dioxide flows and is released into the atmosphere. The airflow carries out freshwater that entered into the system through the Water In inlet 618. Multiple reactor sorbent beds can be used within the system in parallel, and passive timing to direct the gas and water streams can be directed using bell siphons fed by funnels.

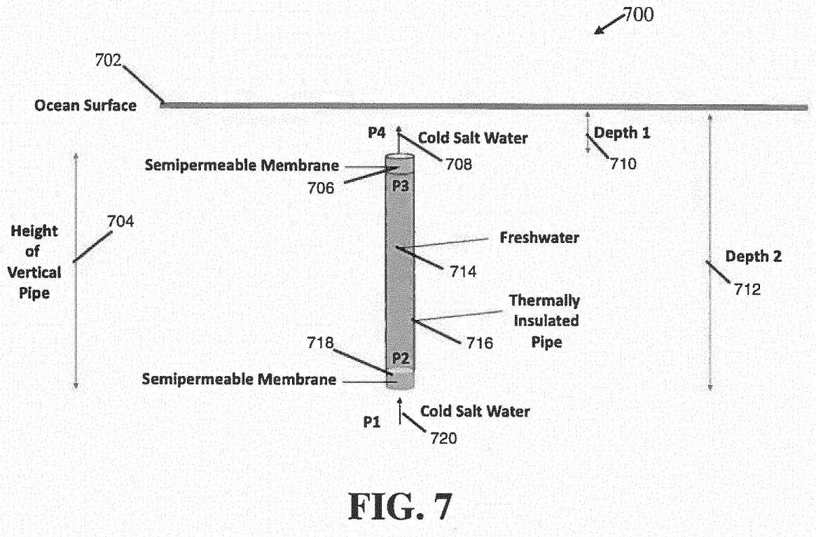

Referring now to FIG. 7, an illustrative view shows another embodiment of Applicant's apparatus, systems, and methods. This embodiment is identified generally by the reference numeral 700. The components of Applicant's apparatus, systems, and methods embodiment 700 illustrated in FIG. 7 are listed below:
Reference Numeral No. 702—ocean surface,
Reference Numeral No. 704—height of vertical pipe,
Reference Numeral No. 706—semipermeable membrane,
Reference Numeral No. 708—cold salt water,
Reference Numeral No. 710—depth 1,
Reference Numeral No. 712—depth 2,
Reference Numeral No. 714—fresh water,
Reference Numeral No. 716—thermally insulated pipe,
Reference Numeral No. 718—semipermeable membrane, and
Reference Numeral No. 720—cold salt water.

The description of the components of the embodiment of Applicant's apparatus, systems, and methods 700 having been completed, the operation and additional description of the Applicant's apparatus, systems, and methods 700 will now be considered in greater detail.

This figure shows an example subsystem that could be used within the invention in order to take in cold water from deep in the ocean and pump it vertically towards the ocean surface, without using complex moving mechanical parts (that introduce potential failure modes). The purposes of pumping water from the deep ocean to shallower parts of the ocean is to take advantage of temperature differences in the water. In many locations, deeper ocean water is much colder than surface ocean water. This temperature difference, coupled with the large heat capacity of water allows for energy extraction (due to the thermal gradient between warm water and cold water). In this invention, cold water can be pumped up towards the surface, where it can be used to reduce the temperature of the dehumidifier (in some cases using a heat exchanger).

This sub-system is comprised of a long vertical pipe 704 that contains freshwater within it and is capped at both openings (the top, 706, and the bottom, 718) with a semipermeable membrane (706/718). This sub-system is fully submerged within the salty ocean, below the ocean surface, as shown. The pipe 716 can be thermally insulated to maintain the temperature difference between the internal and external water.

This subsystem taps into ocean energy for its driving force. Specifically, the energy source that drives this process is the mixing of the ocean (induced for example by waves and currents) which helps to maintain near uniform salinity across the ocean region of interest (pictured here). At P1, cold saltwater 720 is pressed (reverse osmosis) through a semipermeable membrane 718 (thereby desalinating some fraction of the water). Desalinated freshwater 720 will enter into the pipe at P2, while brine is rejected back into the ocean around P1. The vertical pipe contains only freshwater. At the top of the vertical pipe, P3, freshwater passes through a semipermeable membrane, 706, to exit the pipe and remix with surrounding saltwater (forward osmosis) 708. The pipe can be strategically insulated to utilize the thermal gradient between the colder water and the warmer water. For example, the pipe can be insulated everywhere except at P2 and P3. At P2, the bottom portion of the pipe is in thermal contact with the cold surrounding deep ocean water in order to maintain the water that has just entered the pipe at P1 at a low temperature. At P3, the pipe can be placed in thermal contact with a bath (e.g., a heat exchanger) with the intention of chilling the bath. Water flows through this subsystem from P1 to P2 to P3 to P4.

Key to the functioning of this subsystem is the fact that freshwater is approximately 3% less dense than saltwater in the ocean. Let ρₛ be the density of saltwater in the ocean (in this region of interest) and let ρ_{f} be the density of freshwater. (Note that changes in water density due to changes in temperature or changes in pressure are negligible in this subsystem.) Let π denote the osmotic pressure necessary to desalinate freshwater from the saltwater. Saltwater that is desalinated by passing through a semipermeable membrane into freshwater will experience a pressure drop of π. Freshwater passing through a semipermeable membrane into saltwater will experience a pressure gain of π. Depth 2 denotes the depth at which water enters into the pipe, and Depth 1 denotes the depth at which water leaves the pipe. The Height of the Vertical Pipe is given by Depth 2 minus Depth 1. Let g denote the acceleration due to gravity. The pressures at P1, P2, P3, and P4 are given by the following equations:

P1=ρₛg(Depth 2)

P4=ρₛg(Depth1)

P2=P3+ρ_{f}g(Depth 2−Depth 1)

If the following two conditions are met, then water will flow from P1 to P2 to P3 to P4 as desired.

P1>P2+π

P4<P3+π

This subsystem is not a perpetual motion machine. Its source of energy derives from the renewable energy of ocean currents and waves, which serve to mix the seawater so that the salinity remains nearly constant as a function of depth (in the region of interest). In a closed system, devoid of this continual input of mixing, this subsystem would only run for a finite period of time before stopping. In that case, a salinity gradient would build up, preventing further operation. Specifically, in a fully closed system (without ocean energy input), this subsystem would remove freshwater from the local stratum around the bottom of the vertical pipe and introduce freshwater to the local stratum around the top of the pipe, concentrating the salinity around the bottom stratum, while diluting the salinity around the top stratum. These effects are twofold, affecting both the density and osmotic potential of the liquid surrounding the pipe at different depths. In a fully closed system, these effects would tend towards an equilibrium condition until water ceased to be pumped through the vertical pipe.

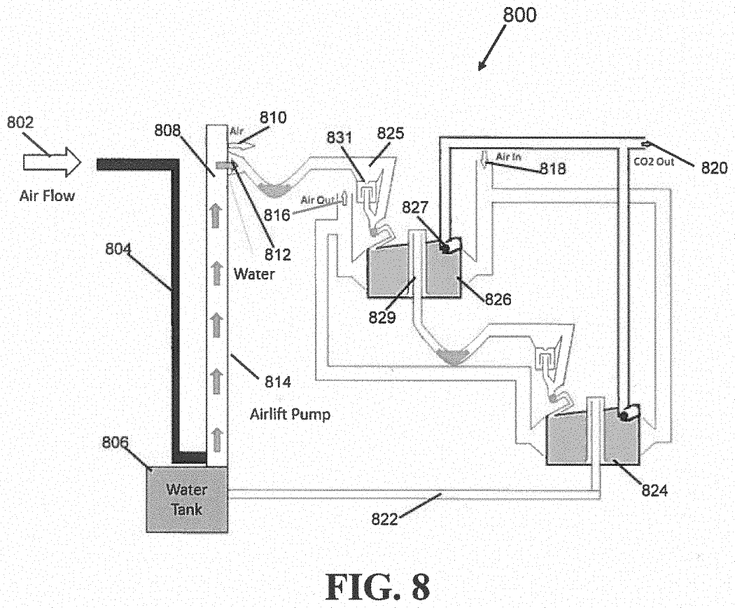

Referring now to FIG. 8, an illustrative view shows another embodiment of Applicant's apparatus, systems, and methods. This embodiment is identified generally by the reference numeral 800. The components of Applicant's apparatus, systems, and methods embodiment 800 illustrated in FIG. 8 are listed below:
Reference Numeral No. 802—air flow,
Reference Numeral No. 804—conduit,
Reference Numeral No. 806—water tank,
Reference Numeral No. 808—freshwater,
Reference Numeral No. 810—air,
Reference Numeral No. 812—water,
Reference Numeral No. 814—air lift pump,
Reference Numeral No. 816—air out,
Reference Numeral No. 818—air in,
Reference Numeral No. 820—CO₂ out,
Reference Numeral No. 822—conduit,
Reference Numeral No. 824—reaction sorbent chamber number two, and
Reference Numeral No. 825—designed void,
Reference Numeral No. 826—reaction sorbent chamber number one.
Reference Numeral No. 827—float valve,
Reference Numeral No. 829—bell siphon number two, and
Reference Numeral No. 831—bell siphon number one.

The description of the components of the embodiment of Applicant's apparatus, systems, and methods 800 having been completed, the operation and additional description of the Applicant's apparatus, systems, and methods 800 will now be considered in greater detail.

This diagram illustrates one implementation of a subsystem that could be used to cycle air and water flows through two parallel moisture swing absorption reaction sorbent chambers at approximately set time intervals. Each reaction sorbent chamber captures carbon dioxide in its dry state and releases carbon dioxide in its wet state (induced by the presence of water on its surface due to contact with liquid water or water vapor). The reaction sorbent chambers thus take on two states, dry and wet, which correspond to the sorbent absorbing and desorbing carbon dioxide, respectively. These two phases are cycled to create a continuing pattern of sorbent loading with carbon dioxide and sorbent regeneration (unloading carbon dioxide). While the sorbent is in its dry state, air is flowed through the reactor bed. This air stream can serve to dry the reactor bed and to introduce carbon dioxide into the reaction sorbent chamber for capture. While the sorbent is in the wet state, no air is flowing through the chamber. Rather, carbon dioxide is released into the liquid water surrounding the sorbent and separated (due to its gaseous phase and low density) to be directed towards sequestration or utilization.

A flow chart describing the working of this subsystem can be broadly described as follows. In step one, both reactor chambers are dry. Air flow 802 into 804, induces the pumping of freshwater from the water tank 806 up to 812, via an airlift pumping mechanism. This water will flow into 825. A large portion of this pumped water will overflow into 826, reactor chamber number one. At this point reactor chamber number one is wet, while reactor chamber number two is dry. Note that the water level in reactor chamber number one is sufficient to raise the float valve 827, thereby allowing a pathway for carbon dioxide that has desorbed from the moisture swing sorbent to escape through the CO₂ Out tube, 820. However, the water level is not sufficient to self-prime bell siphon number two 829 and induce siphoning action. A smaller portion of the pumped water remains trapped in a designed void 825, that slowly funnels into bell siphon number one 831, at a controlled rate. This controlled release of water is a timing mechanism. When sufficient water has siphoned into bell siphon number one, this bell siphon will self-prime, inducing siphoning action that will dump its water content into reaction sorbent chamber number one. When reaction sorbent chamber number one receives this additional input of water, its water level rises sufficiently so as to induce self-priming in bell siphon number two 829. The induced siphoning action has the consequence of dumping the bulk of the water from the upper chambers of this subsystem into the lower chambers of this subsystem. The lower chambers are an identical copy of the upper chambers and the water flow subsequently proceeds in an identical fashion in the lower chambers. Once the water is dumped out of reaction sorbent chamber number two 824 (corresponding to the lower chambers) it will flow back to the water tank 806, and the process will repeat.

The air outlet of the airlift pump, 810, is connected to Air In, 818, by pipes that are not shown in this diagram. Air flow occurs only through a reaction sorbent chamber while it is dry. While a reaction sorbent chamber is wet, the air flow is impeded by the presence of and resistance due to water in the chamber. The sorbent can be structured to have continuous porosity so that air and water can contact the sorbent and flow through the sorbent. Air can be flowed into the system at an approximately constant rate. Depending on the air flow impedances (due to water in the reaction sorbent chamber), the air will either flow through reaction sorbent chamber number one, reaction sorbent chamber number two, or both, before exiting the subsystem. U-tube junctions are designed into the system to retain some water, sealing their pathways to significant gas phase backflow. Furthermore, float valves are incorporated to maintain a seal on a reaction sorbent chamber when it is dry. This helps to prevent air from flowing into the CO₂ Out tube, and to prevent carbon dioxide from backflowing.

This subsystem cycles as follows:

1. Reaction sorbent chamber number one and reaction sorbent chamber number two are dry.

2. Water is pumped from the water tank into reaction sorbent chamber number one. Reaction sorbent chamber number one is wet, while reaction sorbent chamber number two is dry. Carbon dioxide is released from reaction sorbent chamber number one through the CO₂ Out tube, while air flows through reaction sorbent chamber number two, loading the sorbent with carbon dioxide.

3. Due to two self-priming siphons, water is dumped from reaction sorbent chamber number one into reaction sorbent chamber number two. Now reaction sorbent chamber number two is wet, and reaction sorbent chamber number one is dry. Carbon dioxide is released from reaction sorbent chamber number two through the CO₂ Out tube, while air flows through reaction sorbent chamber number one, loading the sorbent with carbon dioxide.

4. Due to self-priming siphons, water is dumped from reaction sorbent chamber number two into the water tank. This restarts the cycle, by automatically resetting conditions for the airlift pump to pump water into reaction sorbent chamber number one.

The overall result is that carbon dioxide is captured and ejected through the CO₂ Out tube for the purposes of sequestration or use. At the same time, air, along with evaporated water is released through the Air Out tube. This cycle continues to repeat at approximately regular intervals dictated by the dimensions of the system (especially the bell siphons and the funnels feeding water into the bell siphons). Of importance, this subsystem only uses fluidics and simple valves (e.g., float valves) thereby minimizing possible failure modes that would be introduced by the use of complex moving mechanical parts.

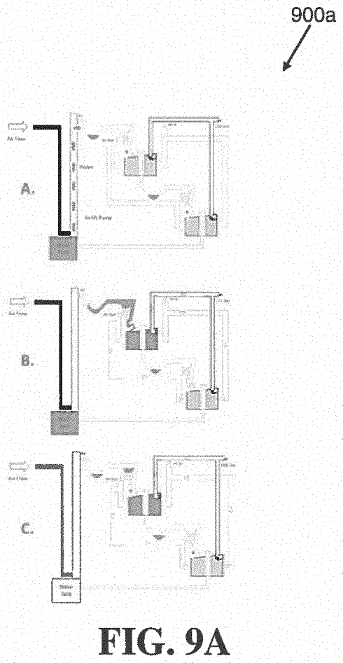

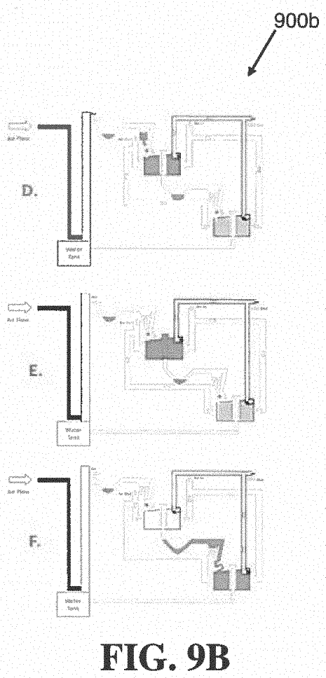

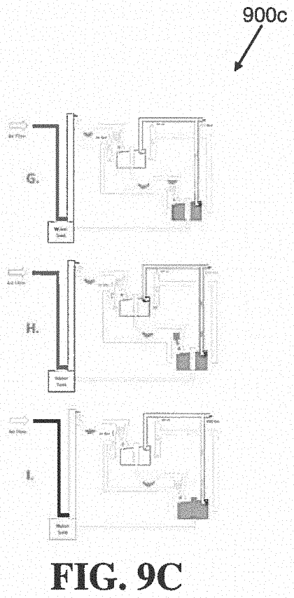

Referring now to FIGS. 9A 9B, and 9C, diagrams A through I show the approximate flow of water throughout the subsystem. In step one, both reactor chambers are dry. Air flow induces the pumping of water from the water tank via an airlift pumping mechanism. A large portion of this pumped water will overflow into reactor chamber number one. At this point reactor chamber number one is wet, while reactor chamber number two is dry. Note that the water level in reactor chamber number one is sufficient to raise the float valve, thereby allowing a pathway for carbon dioxide that has desorbed from the moisture swing sorbent to escape through the CO₂ an out tube. However, the water level is not sufficient to self-prime siphon number two and induce siphoning action. A smaller portion of the pumped water remains trapped in a designed void, that slowly funnels into bell siphon number one, at a controlled rate. This controlled release of water is timing mechanism. When sufficient water has siphoned into bell siphon number one, this bell siphon with self-prime, inducing siphoning action that will dump its water content into reactor chamber number one. When reactor chamber number one receives this additional input of water, its water level rises sufficiently so as to induce self-priming in bell siphon number two. The induced siphoning action has the consequence of dumping the bulk of the water from the upper chambers into the lower chambers. The lower chambers are an identical copy of the upper chambers and the water flow subsequently proceeds in an identical fashion in the lower chambers. Once the water is dumped out of the lower chamber it will flow back to the water tank, and the process will repeat.

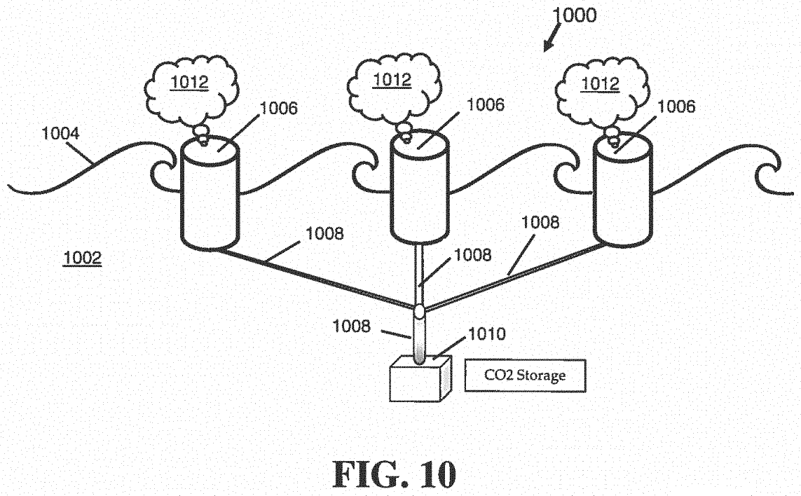

Referring now to FIG. 10, an illustrative view shows an embodiment of Applicant's apparatus, systems, and methods. This embodiment is identified generally by the reference numeral 1000. The components of Applicant's apparatus, systems, and methods 1000 illustrated in FIG. 10 are listed below:
Reference Numeral No. 1002—body of water,
Reference Numeral No. 1004—water waves,
Reference Numeral No. 1006—Module,
Reference Numeral No. 1008—conduit,
Reference Numeral No. 1010—CO₂ storage, and
Reference Numeral No. 1012—air.

The description of the structural components of the Applicants' apparatus, systems, and methods embodiment 1000 having been completed, the operation and additional description of the Applicant's apparatus, systems, and methods embodiment will now be considered in greater detail. Applicant's apparatus, systems, and methods 1000 provide an ocean-based direct-air-capture device with CO₂ storage.

Applicant's apparatus, systems, and methods 1000 provide direct air capture in a body of water 1002 that has waves 1004 with wave motion. At least one module 1006 is exposed to the waves 1004. Relative movement between module 1006 and waves 1004 is used to draw air 1012 into module 1006 wherein the air 1012 includes carbon dioxide (CO₂). Fluidics within module 1006 removes the carbon dioxide from the air 1012. In various embodiments a moisture swing absorbent is used to remove the carbon dioxide from the air 1012. The carbon dioxide that has been removed from the air 1012 is transferred to CO₂ storage unit 1010. As illustrated in FIG. 10 the module 1006 floats on the body of water 1002 and moves with the waves 1004 to draw air 1012 into the module 1006.

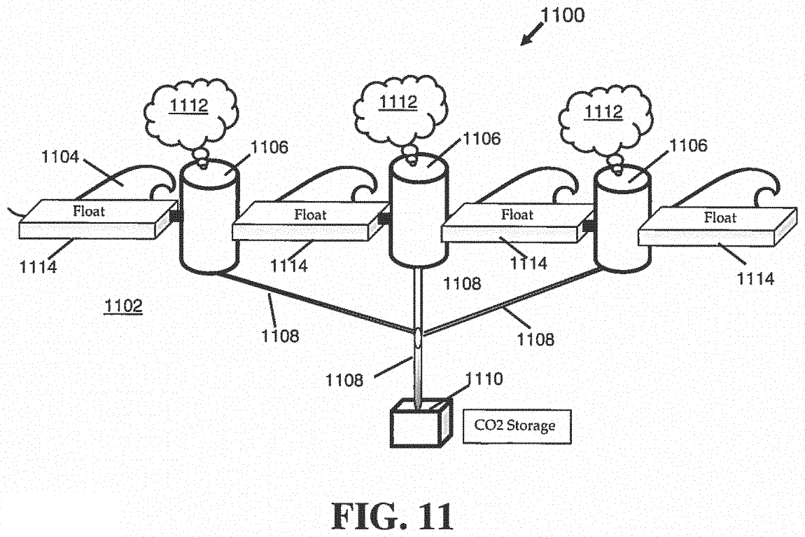

Referring now to FIG. 11, an illustrative view shows an embodiment of Applicant's apparatus, systems, and methods. This embodiment is identified generally by the reference numeral 1100. The components of Applicant's apparatus, systems, and methods 1100 illustrated in FIG. 11 are listed below:
Reference Numeral No. 1102—body of water,
Reference Numeral No. 1104—water waves,
Reference Numeral No. 1106—Module,
Reference Numeral No. 1108—conduit,
Reference Numeral No. 1110—CO₂ storage,
Reference Numeral No. 1112—air, and
Reference Numeral No. 1114—float.

The description of the structural components of the Applicants' apparatus, systems, and methods embodiment 1100 having been completed, the operation and additional description of the Applicant's apparatus, systems, and methods embodiment will now be considered in greater detail. Applicant's apparatus, systems, and methods 1100 provide an ocean-based direct-air-capture device with CO₂ storage.

Applicant's apparatus, systems, and methods 1100 provide direct air capture in a body of water 1102 that has waves 1104 with wave motion. At least one module 1106 is exposed to the waves 1104. Relative movement between module 1106 and waves 1104 is used to draw air 1112 into module 1106 wherein the air 1112 includes carbon dioxide (CO₂). Fluidics within module 1106 removes the carbon dioxide from the air 1112. In various embodiments a moisture swing absorbent is used to remove the carbon dioxide from the air 1112. The carbon dioxide that has been removed from the air 1112 is transferred to CO₂ storage unit 1110 through conduits 1108. As illustrated in FIG. 11 the module 1106 remains stationary on the body of water 1102 and the waves 1104 move up and down on the module 1106. The wave motion draws air into the module 1106. The module(s) 1106 are connected to floats 1114 that float on the body of water 1102 maintaining the module(s) 1106 in a stationary position with regard to the waves 1104 thus providing relative movement between the waves 1104 and the module(s) 1106. A sufficient number of floats 1114 enables the module 1106 to act as a barge and remain in a stationary position with regard to the waves 1104. If fewer floats 1114 are used the system acts as a hybrid with relative up and down movement between module 1106 and waves 1104.

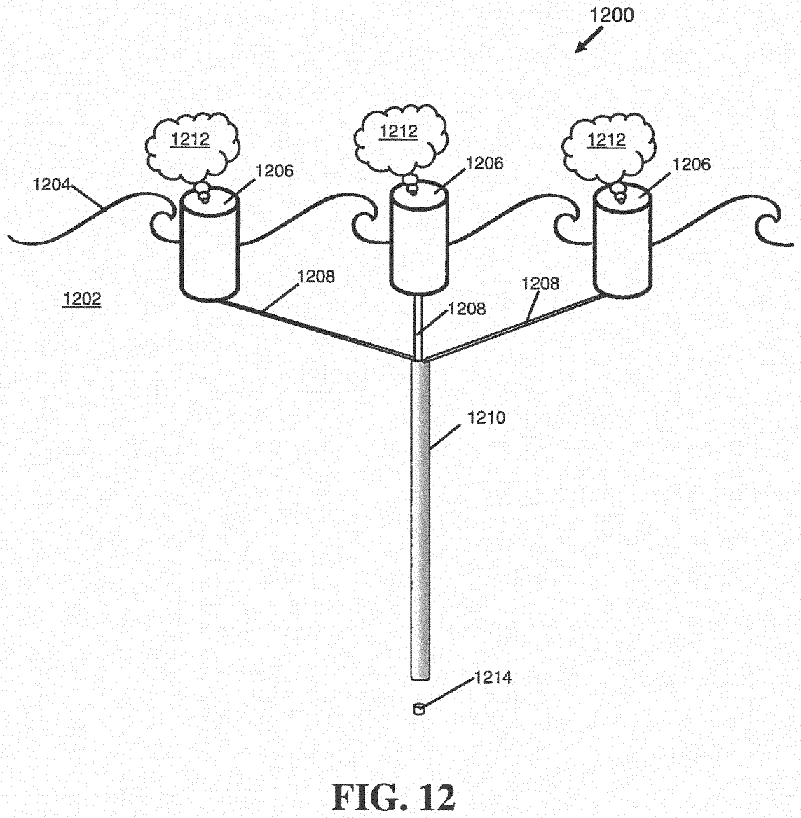

Referring now to FIG. 12, an illustrative view shows an embodiment of Applicant's apparatus, systems, and methods. This embodiment is identified generally by the reference numeral 1200. The components of Applicant's apparatus, systems, and methods 1200 illustrated in FIG. 12 are listed below:
Reference Numeral No. 1202—body of water,
Reference Numeral No. 1204—water waves,
Reference Numeral No. 1206—Module,
Reference Numeral No. 1208—conduit,
Reference Numeral No. 1210—pipe,
Reference Numeral No. 1212—air, and
Reference Numeral No. 1214—CO₂ clathrate.

The description of the structural components of the Applicants' apparatus, systems, and methods embodiment 1200 having been completed, the operation and additional description of the Applicant's apparatus, systems, and methods embodiment will now be considered in greater detail. Applicant's apparatus, systems, and methods 1200 provide an ocean-based direct-air-capture device with CO₂ storage.

Applicant's apparatus, systems, and methods 1200 provide direct air capture in a body of water 1202 that has waves 1204 with wave motion. At least one module 1206 is exposed to the waves 1204. Relative movement between module 1206 and waves 1204 is used to draw air 1212 into module 1206 wherein the air 1212 includes carbon dioxide (CO₂). As illustrated in FIG. 12 the module 1206 floats on the body of water 1202 and moves with the waves 1204 to draw air 1212 into the module 1206. Fluidics within module 1206 removes the carbon dioxide from the air 1212. In various embodiments a moisture swing absorbent is used to remove the carbon dioxide from the air 1212.

The carbon dioxide that has been removed from the air 1212 is directed down a 500-meter vertical pipe 1210 (shared by multiple modules in an ocean-based module farm. At the bottom of the vertical pipe 1210, the CO₂ is pushed through a reactor that forms CO₂ clathrate hydrates 1214. This solid 1214 then sinks to the floor of the body of water sequestering the captured carbon dioxide in a stable solid form.

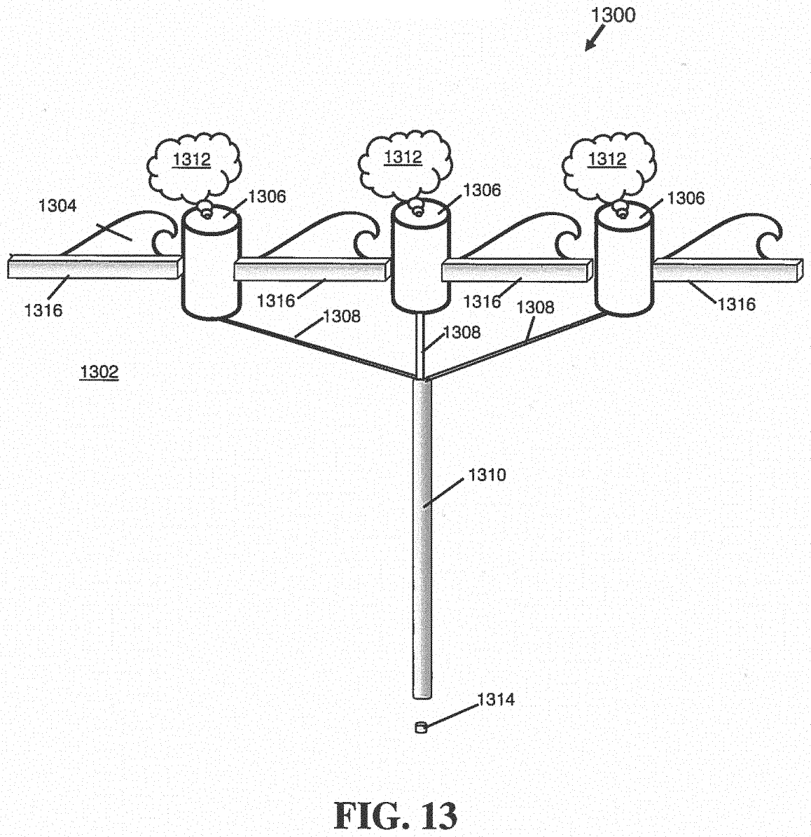

Referring now to FIG. 13, an illustrative view shows an embodiment of Applicant's apparatus, systems, and methods. This embodiment is identified generally by the reference numeral 1300. The components of Applicant's apparatus, systems, and methods 1300 illustrated in FIG. 13 are listed below:
Reference Numeral No. 1302—body of water,
Reference Numeral No. 1304—water waves,
Reference Numeral No. 1306—Module,
Reference Numeral No. 1308—conduit,
Reference Numeral No. 1310—pipe,
Reference Numeral No. 1312—air,
Reference Numeral No. 1314—CO₂ Caltrate, and
Reference Numeral No. 1316—float.

The description of the structural components of the Applicants' apparatus, systems, and methods embodiment 1300 having been completed, the operation and additional description of the Applicant's apparatus, systems, and methods embodiment will now be considered in greater detail. Applicant's apparatus, systems, and methods 1300 provide an ocean-based direct-air-capture device with CO₂ sequestration.

Applicant's apparatus, systems, and methods 1300 provide direct air capture in a body of water 1302 that has waves 1304 with wave motion. At least one module 1306 is exposed to the waves 1304. Relative movement between module 1306 and waves 1304 is used to draw air 1312 into module 1306 wherein the air 1312 includes carbon dioxide (CO₂). Fluidics within module 1306 removes the carbon dioxide from the air 1312. In various embodiments a moisture swing absorbent is used to remove the carbon dioxide from the air 1312.

The carbon dioxide that has been removed from the air 1312 is directed down a 500-meter vertical pipe 1310 (shared by multiple modules in an ocean-based module farm. At the bottom of the vertical pipe 1310, the CO₂ is pushed through a reactor that forms CO₂ clathrate hydrates 1314. This solid 1314 then sinks to the floor of the body of water sequestering the captured carbon dioxide in a stable solid form.

As illustrated in FIG. 13 the module 1306 remains stationary on the body of water 1302 and the waves 1304 move up and down on the module 1306. The wave motion draws air into the module 1306. The module(s) 1306 are connected to floats 1314 that float on the body of water 1302 maintaining the module(s) 1306 in a stationary position with regard to the waves 1304 thus providing relative movement between the waves 1304 and the module(s) 1306. A sufficient number of floats 1314 enables the module 1306 to act as a barge and remain in a stationary position with regard to the waves 1304. If fewer floats 1314 are used the system acts as a hybrid with relative up and down movement between module 1306 and waves 1304.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. A method of direct air capture in a body of water that has waves with wave motion, comprising the steps of;
providing at least one module exposed to the waves,
utilizing the wave motion to draw air into said module wherein said air includes carbon dioxide, and
removing said carbon dioxide from said air.

2. The method of claim 1 wherein said step of utilizing the wave motion to draw air into said module comprises utilizing relative movement between said at least one module and said waves to draw air into said module.

3. The method of claim 2 wherein said step of utilizing relative movement between said at least one module said waves to draw air into said module comprises having said at least one module float on the body of water and move with the waves to draw air into said module.

4. The method of claim 2 wherein said step of utilizing relative movement between said at least one module said waves to draw air into said module comprises having said at least one module remain stationary on the body of water and having the wave motion draw air into said module.

5. The method of claim 1 wherein said step of removing said carbon dioxide from said air includes using a moisture swing absorbent to remove said carbon dioxide from said air.

6. The method of claim 1 including a float with said module wherein said float provides relative movement between said at least one module said waves to draw air into said module.

7. The method of claim 6 wherein said step including a float with said module comprises having said at least one module float on the body of water and move with the waves to draw air into said module.

8. The method of claim 6 wherein said step including a float with said module comprises having said at least one module remain stationary on the body of water and having the wave motion draw air into said module.

9. The method of claim 1 wherein said water is salt water and further comprising the step of creating fresh water from said salt water and removing said carbon dioxide from said air using a moisture swing absorbent interacting with said fresh water.

10. The method of claim 9 wherein said step of creating fresh water from said salt water includes using a humidifier and a dehumidifier for creating fresh water from said salt water.

11. The method of claim 9 further comprising using a solar thermal heater with said humidifier and said dehumidifier.

12. The method of claim 1 further comprising providing a reactor in said module that produces carbon dioxide clathrates from said carbon dioxide that has been removed from said air.

13. The method of claim 1 further comprising the step of providing reactor in said module that produces carbon dioxide clathrates.

14. The method of claim 13 further comprising the step of directing said carbon dioxide clathrates into said body of water allowing said carbon dioxide clathrates to sink in said body of water.

15. The method of claim 13 further comprising the step of directing said carbon dioxide clathrates into a conduit extending at least 500 meters into said body of water allowing said carbon dioxide clathrates to sink in said body of water.

16. The method of claim 1 wherein said step of removing said carbon dioxide from said air includes the steps of controlling timing and switching of fluid flows and further comprising the step of using one or more self-priming siphons to control said timing and switching of fluid flows.

17. A direct air capture apparatus adapted to operate in a body of water that has waves with wave motion, comprising;
at least one module carried by the waves,
fluidics in said module that utilizes the wave motion to draw air into said module wherein said air includes carbon dioxide, and
systems in said module that remove said carbon dioxide from said air,

18. The direct air capture apparatus of claim 17 wherein said module includes a float.

19. The direct air capture apparatus of claim 17 wherein said module includes a float that moves with the waves to draw air into said module.

20. The direct air capture apparatus of claim 17 wherein said at least one module remain stationary on the body of water and wherein the wave motion draws air into said module.

21. The direct air capture apparatus of claim 17 further comprising a moisture swing absorbent that removes said carbon dioxide from said air.

22. The direct air capture apparatus of claim 17 further comprising a humidifier and a dehumidifier.

23. The direct air capture apparatus of claim 17 further comprising a solar thermal heater.

24. The direct air capture apparatus of claim 17 further comprising a reactor in said module that produces carbon dioxide clathrates from said carbon dioxide that has been removed from said air.

25. The direct air capture apparatus of claim 24 further comprising a system for directing said carbon dioxide clathrates into said body of water allowing said carbon dioxide clathrates to sink in said body of water.

26. The apparatus of claim 17 wherein said systems in said module that remove said carbon dioxide from said air include systems of controlling timing and switching of fluid flows and further comprising system with one or more self-priming siphons in said systems of controlling timing and switching of fluid flows.

27. An apparatus for direct air capture in a body of water that has waves with wave motion, comprising;
at least one module exposed to the waves,
means for utilizing the wave motion to draw air into said module wherein said air includes carbon dioxide, and
means for removing said carbon dioxide from said air.

28. The apparatus of claim 27 wherein said means for utilizing the wave motion to draw air into said module comprises means for utilizing relative movement between said at least one module and said waves to draw air into said module.

29. The apparatus of claim 27 wherein said means for utilizing relative movement between said at least one module said waves to draw air into said module comprises means for having said at least one module float on the body of water and move with the waves to draw air into said module.

30. The apparatus of claim 27 wherein said means for utilizing relative movement between said at least one module said waves to draw air into said module comprises means for having said at least one module remain stationary on the body of water and having the wave motion draw air into said module.

31. The apparatus of claim 27 wherein said means for removing said carbon dioxide from said air includes a moisture swing absorbent that removes said carbon dioxide from said air.

32. The apparatus of claim 27 including a float with said module wherein said float provides relative movement between said at least one module said waves to draw air into said module.

33. The apparatus of claim 27 including a float with said module having said at least one module float on the body of water and move with the waves to draw air into said module.

34. The apparatus of claim 27 wherein said at least one module remains stationary on the body of water and the wave motion draws air into said module.

35. The apparatus of claim 27 wherein said water is salt water and further comprising means for creating fresh water from said salt water and locating said carbon dioxide in said fresh water and removing said carbon dioxide from said air using a moisture swing absorbent interacting with said fresh water.

36. The apparatus of claim 35 wherein said means for creating fresh water from said salt water includes using a humidifier and a dehumidifier for creating fresh water from said salt water.

37. The apparatus of claim 36 further comprising a solar thermal heater used with said humidifier and said dehumidifier.

38. The apparatus of claim 27 further comprising a reactor in said module that produces carbon dioxide clathrates from said carbon dioxide that has been removed from said air.

39. The apparatus of claim 38 further comprising means for directing said carbon dioxide clathrates into said body of water allowing said carbon dioxide clathrates to sink in said body of water.

40. The apparatus of claim 39 further comprising a conduit extending at least 500 meters into said body of water allowing said carbon dioxide clathrates to sink in said body of water.
